(19) United States
(12) Patent Application Publication
(10) Pub. No.: US 2026/0179848 A1
(43) Pub. Date: Jun. 25, 2026

(54) MULTILAYER ELECTRONIC COMPONENT

(71) Applicant: SAMSUNG ELECTRO-MECHANICS CO., LTD., Suwon-si (KR)

(72) Inventors: Sun Kyoung Park, Suwon-si (KR); Chae Dong Lee, Suwon-si (KR)

(73) Assignee: SAMSUNG ELECTRO-MECHANICS CO., LTD., Suwon-si (KR)

(21) Appl. No.: 19/325,274

(22) Filed: Sep. 10, 2025

(30) Foreign Application Priority Data
Dec. 20, 2024 (KR) 10-2024-0192969

(51) Int. Cl. H01G 4/232; H01G 4/30

(52) U.S. Cl. CPC H01G 4/2325; H01G 4/30

(57) ABSTRACT

A multilayer electronic component includes a body including a dielectric layer and an internal electrode; and an external electrode disposed on the third and fourth surfaces, wherein the external electrode includes a conductive resin layer including metal particles and a resin, and the metal particles include spherical particles and plate-shaped particles, wherein a cross-section of the external electrode in first and second directions include a lower region disposed below in the first direction and an upper region disposed above in the first direction, and the conductive resin layer may have a higher area ratio of spherical particles to the metal particles in the upper region than in the lower region.

### CROSS-REFERENCE TO RELATED APPLICATION

This application claims benefit of priority to Korean Patent Application No. 10-2024-0192969 filed on Dec. 20, 2024, the disclosure of which is incorporated herein by reference in its entirety.

### TECHNICAL FIELD

The present disclosure relates to a multilayer electronic component.

A multilayer ceramic capacitor (MLCC), a multilayer electronic component, may be a chip-type condenser mounted on the printed circuit boards of various electronic products, such as an imaging device, including a liquid crystal display (LCD) or a plasma display panel (PDP), a computer, a smartphone, or a mobile phone, serving to charge or discharge electricity therein or therefrom.

Such a multilayer ceramic capacitor has a small size, implements high capacitance, and is easily mounted on a circuit board, and may thus be used as a component of various electronic devices.

In order to secure high reliability and high strength characteristics, a method of changing an external electrode comprised of a conventional electrode layer to a two-layer structure of an electrode layer and a conductive resin layer was proposed.

The two-layer structure of the electrode layer and the conductive resin layer may improve bending strength by absorbing external impacts by applying a resin composition containing a conductive material on the electrode layer.

However, there was a concern that equivalent series resistance (ESR) would increase when a conductive resin layer was applied to the external electrode.

Accordingly, there was an attempt to reduce ESR and secure bending strength by minimizing the conductive resin layer by making a thickness of the conductive resin layer in a lower region of the external electrode thicker than that in an upper region thereof. In this case, there is a limitation that the bending strength can only be secured by being mounted in a specific direction, and it may be difficult to sufficiently secure bending strength and moisture resistance reliability.

In addition, as the standards for high reliability and high strength characteristics required by the industry are becoming increasingly higher, a method for further improving high reliability and high strength characteristics are required.

### SUMMARY

An aspect of the present disclosure is to provide a multilayer electronic component having excellent reliability.

An aspect of the present disclosure is to provide a multilayer electronic component having improved bending strength.

An aspect of the present disclosure is to suppress plating breakage defects.

However, various problems to be solved by the present disclosure are not limited to the above-described contents, and can be more easily understood in the process of explaining specific embodiments of the present disclosure.

According to an aspect of the present disclosure, a multilayer electronic component includes a body including a dielectric layer and an internal electrode, the body including first and second surfaces opposing each other in a first direction, third and fourth surfaces connected to the first and second surfaces and opposing each other in a second direction, and fifth and sixth surfaces connected to the first to fourth surfaces and opposing each other in a third direction; and an external electrode disposed on the third and fourth surfaces, wherein the external electrode includes a conductive resin layer including metal particles and a resin, and the metal particles include spherical particles and plate-shaped particles, wherein a cross-section of the external electrodes in first and second directions include a lower region disposed therebelow in the first direction and an upper region disposed thereabove in the first direction, and the conductive resin layer has a higher area ratio of spherical particles to the metal particles in the upper region than in the lower region.

According to an aspect of the present disclosure, a multilayer electronic component comprises a body including a dielectric layer and an internal electrode, the body including a first surface and a second surface opposing each other in a first direction, a third surface and a fourth surface connected to the first surface and the second surface and opposing each other in a second direction, and the fifth surface and the sixth surface connected to the first surface, the second surface, the third surface, and the fourth surface and opposing each other in a third direction; and an external electrode disposed on the third surface and the fourth surface, wherein the external electrode includes a conductive resin layer including metal particles and a resin, and the metal particles include spherical particles and plate-shaped particles, wherein a cross-section of the external electrode in the first direction and the second direction include a lower region disposed below in the first direction and an upper region disposed above in the first direction, and wherein the conductive resin layer has a higher area ratio of spherical particles to the metal particles in the upper region than in the lower region.

According to an aspect of the present disclosure, the multilayer electronic component further includes each of the upper region and the lower region of the cross-section of the external electrode includes a convex shape in the second direction.

According to an aspect of the present disclosure, the multilayer electronic component further includes the external electrode includes a concave shape in the second direction between the convex shape in the upper region and the convex shape in the lower region.

According to an aspect of the present disclosure, the multilayer electronic component further includes a maximum thickness of the external electrode in the second direction in the lower region is tm1, a maximum thickness of the external electrode in the second direction in the upper region is tm2, a minimum thickness of the external electrode in the second direction in a central portion thereof in the first direction is tmin, and tmin<tm1 and tmin<tm2 are satisfied.

According to an aspect of the present disclosure, the multilayer electronic component of further includes the external electrode comprising a side band portion extending to a portion of each of the fifth surface and the sixth surface, wherein a first length of the side band portion in the second direction decreases from an uppermost end of the body in the first direction to a central portion of the body in the first direction, and a second length of the side band portion in the second direction decreases from a lowermost end of the body in the first direction to the central portion of the body in the first direction.

According to an aspect of the present disclosure, the multilayer electronic component further includes the external electrode comprises a side band portion extending to a portion of each of the fifth surface and the sixth surface, the external electrode includes a first external electrode disposed on the third surface and a second external electrode disposed on the fourth surface, a minimum length in the second direction from an extension line of the third surface to an end of the side band portion of the first external electrode in a central portion in the first direction is Lbc, a length in the second direction from the extension line of the third surface to the end of the side band portion of the first external electrode at a lowermost end of the body in the first direction is Lb1, a length in the second direction from the extension line of the third surface to the end of the side band portion of the first external electrode at an uppermost end of the body in the first direction is Lb2, and Lbc<Lb2 and Lbc<Lb1 are satisfied.

According to an aspect of the present disclosure, the multilayer electronic component includes the external electrode further including an electrode layer disposed on the body and connected to the internal electrode, and the conductive resin layer is disposed on the electrode layer.

According to an aspect of the present disclosure, the multilayer electronic component includes the electrode layer including a convex shape in the second direction in the central portion in the first direction.

According to an aspect of the present disclosure, the multilayer electronic component further includes a first thickness of the electrode layer in the second direction in the central portion in the first direction is ta1, a second thickness of the electrode layer in the second direction in the internal electrode disposed at an uppermost end of internal electrodes in the first direction, connected to the electrode layer is ta2, and a third thickness of the electrode layer in the second direction in an internal electrode disposed at a lowermost end of internal electrodes in the first direction, connected to the electrode layer is ta3, and ta1>ta2 and ta1>ta3 are satisfied.

According to an aspect of the present disclosure, the multilayer electronic component further includes the body including a margin portion disposed between the internal electrode and the fifth surface and the sixth surface, and each of the upper region and the lower region of cross-section of the external electrode has a convex shape in the second direction.

According to an aspect of the present disclosure, the multilayer electronic component further includes the external electrode including a concave shape in the second direction between a convex shape of the external electrode disposed in the upper region and a convex shape of the external electrode disposed in the lower region.

According to an aspect of the present disclosure, the multilayer electronic component further includes the conductive resin layer including a first layer disposed in the lower region and a second layer disposed in the upper region, and the second layer having a higher area ratio of spherical particles to metal particles than the first layer.

According to an aspect of the present disclosure, the multilayer electronic component further includes the first layer having an area ratio of spherical particles to metal particles of 50% or more and 70% or less, and the second layer having an area ratio of spherical particles to metal particles of 97.5% or more.

According to an aspect of the present disclosure, the multilayer electronic component further includes an area ratio of the metal particles to total particles in the first layer of 60% or more and 70% or less, and an area ratio of the metal particles to total particles in the second layer of 70% or more and 90% or less.

According to an aspect of the present disclosure, the multilayer electronic component further includes the spherical particles having a first length ratio of a minor axis to a major axis of 1.45 or less, and plate-shaped particles having a second length ratio of the minor axis to the major axis of 1.95 or more.

According to an aspect of the present disclosure, the multilayer electronic component further includes the first layer disposed in the upper region, and the second layer disposed on the first layer in the upper region.

According to an aspect of the present disclosure, the multilayer electronic component further includes the first layer having an average thickness in the second direction in the upper region thinner than an average thickness in the second direction in the lower region.

According to an aspect of the present disclosure, the multilayer electronic component further includes the first layer and the second layer spaced apart from each other.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an embodiment of the present disclosure;

FIG. 2 is a schematic cross-sectional view of FIG. 1, taken along line I-I′;

FIG. 3 is a schematic cross-sectional view of FIG. 1, taken along line II-II′;

FIG. 4 is a schematic view of a body disassembled;

FIG. 5 is an enlarged view of a first external electrode region in FIG. 2;

FIG. 6 is a side view of a multilayer electronic component looking at a sixth surface; and

FIG. 7 is a diagram corresponding to FIG. 2, of a multilayer electronic component according to another embodiment of the present disclosure.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numeral are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

In the drawings, an X-direction may be defined as a first direction, a stacking direction, or a thickness (T) direction, a Y-direction may be defined as a second direction or a length (L) direction, and a Z direction may be defined as a third direction or a width (W) direction.

### Multilayer Electronic Component

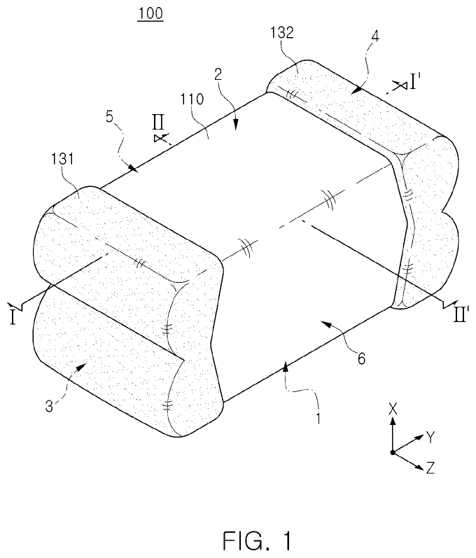

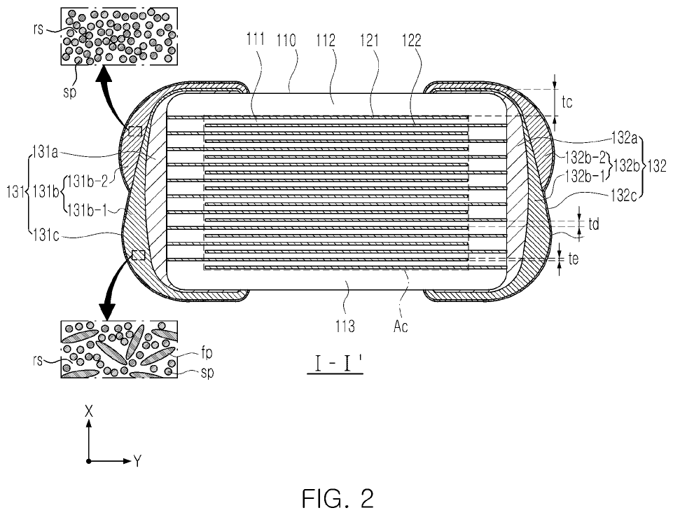

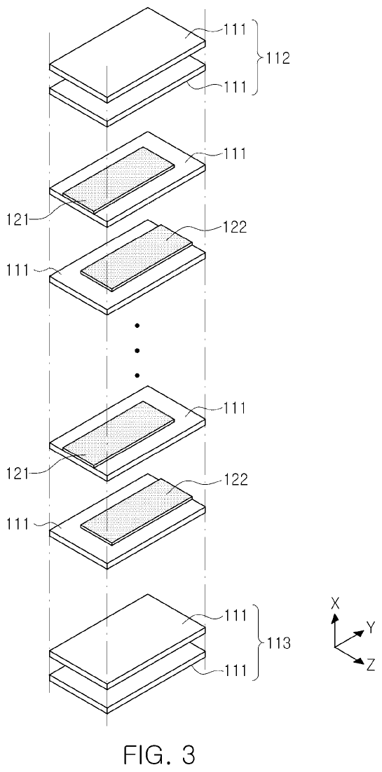

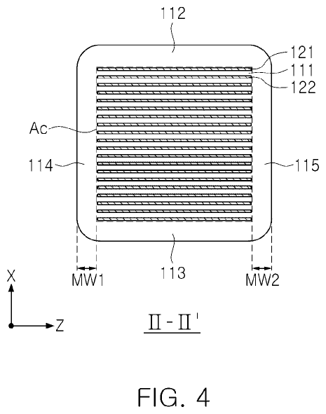

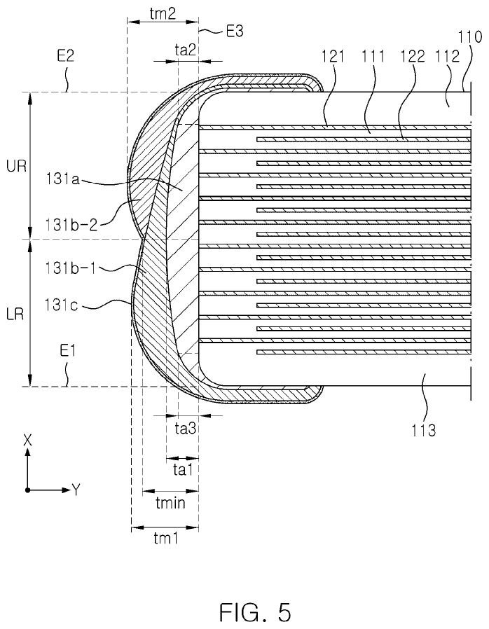

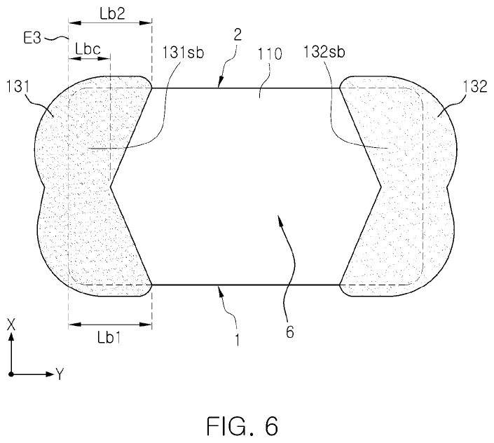

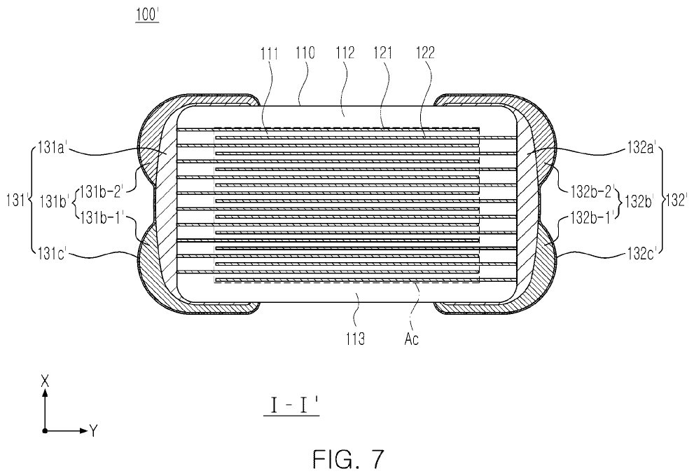

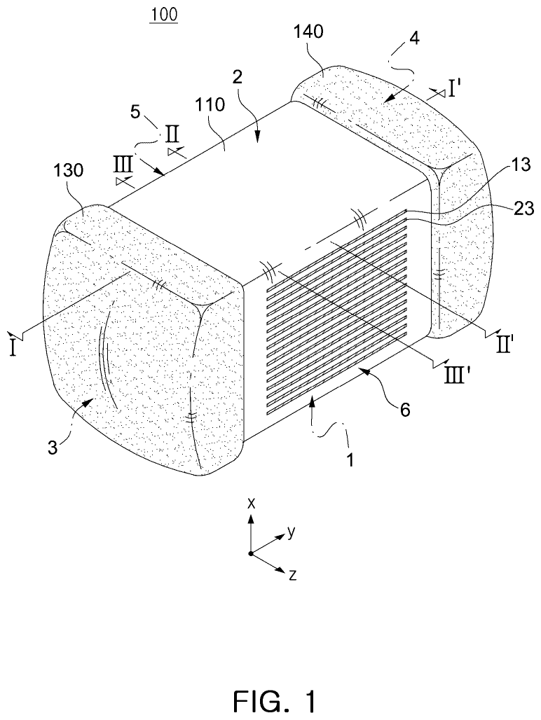

FIG. 1 is a schematic perspective view of a multilayer electronic component according to an embodiment of the present disclosure.

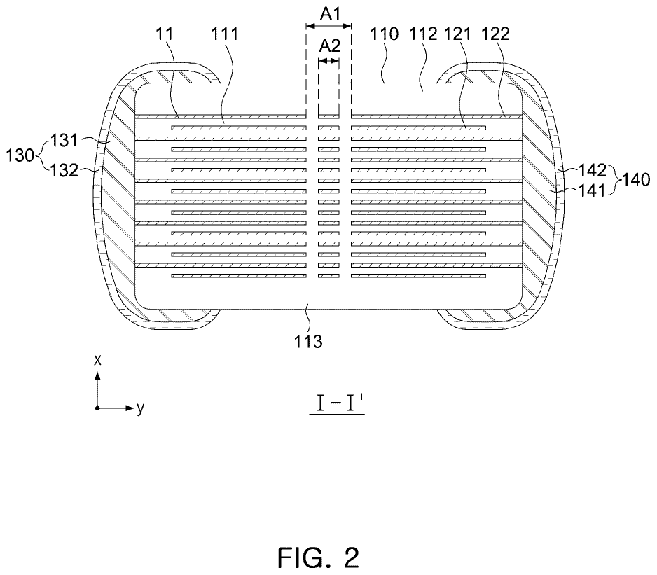

FIG. 2 is a schematic cross-sectional view of FIG. 1, taken along line I-I′.

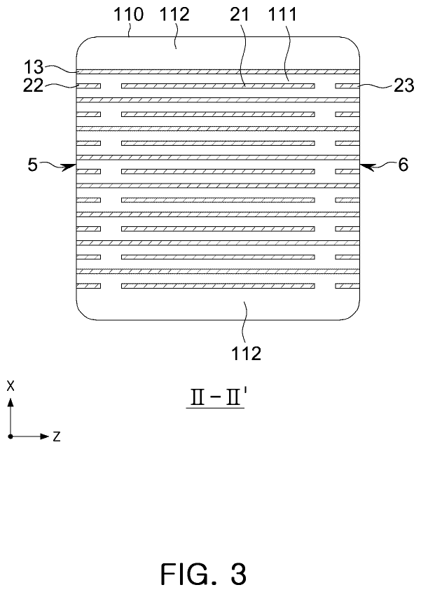

FIG. 3 is a schematic cross-sectional view of FIG. 1, taken along line II-II′.

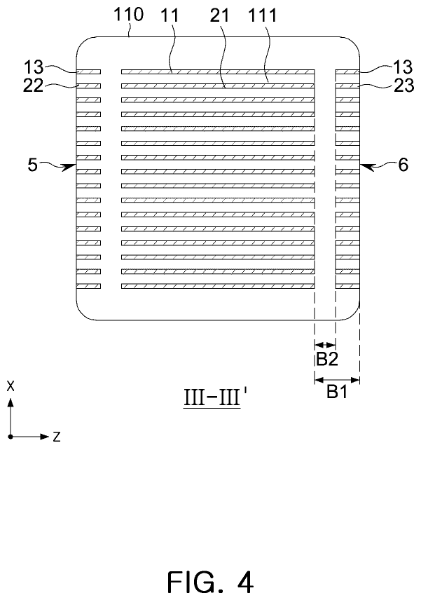

FIG. 4 is a schematic view of a body disassembled.

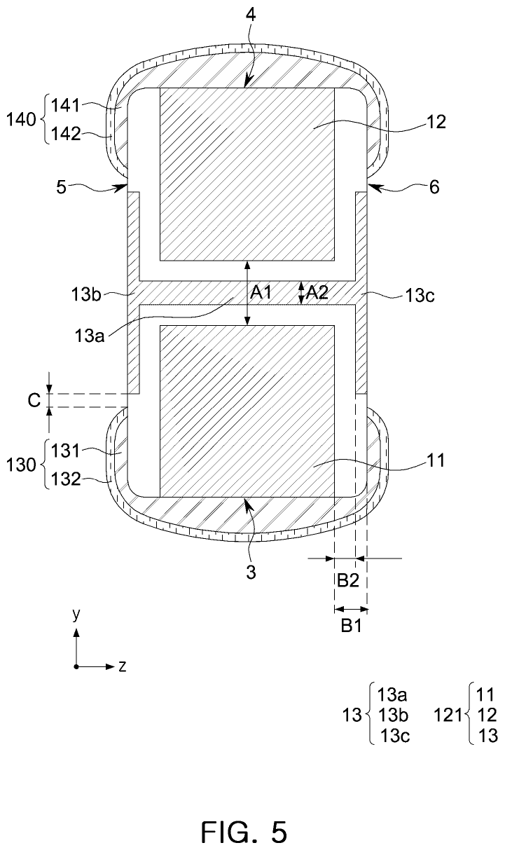

FIG. 5 is an enlarged view of a first external electrode region in FIG. 2.

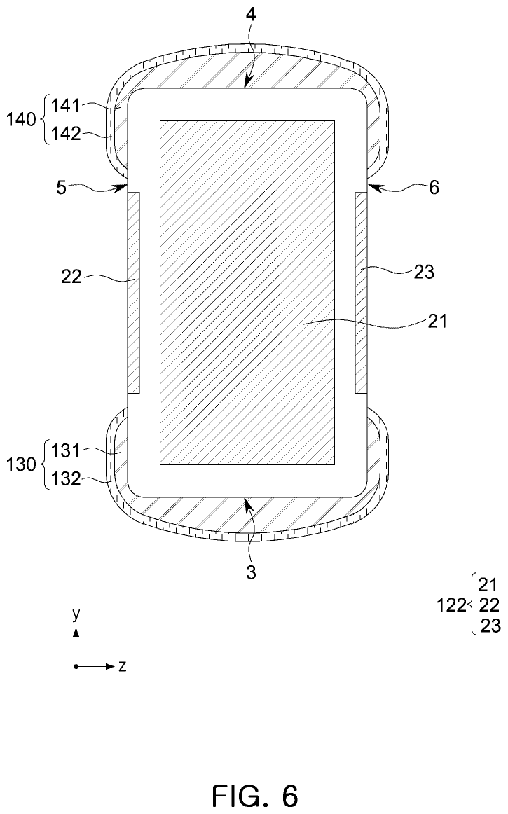

FIG. 6 is a side view of a multilayer electronic component looking at a sixth surface.

Hereinafter, a multilayer electronic component 100 according to an embodiment in the present disclosure will be described with reference to FIGS. 1 to 6. In addition, a multi-layered ceramic capacitor (hereinafter referred to as ‘MLCC’) will be described as an example of a multilayer electronic component, but the present disclosure is not limited thereto, and it may also be applied to various multilayer electronic components such as an inductor and piezoelectric elements, varistors, thermistors, or the like.

According to an embodiment of the present disclosure, the multilayer electronic component 100 may include a body 110 including a dielectric layer 111 and internal electrodes 121 and 122, the body 110 including first and second surfaces 1 and 2 opposing each other in a first direction, third and fourth surfaces 3 and 4 connected to the first and second surfaces and opposing each other in a second direction, and fifth and sixth surfaces 5 and 6 connected to the first to fourth surfaces and opposing each other in a third direction; and external electrodes 131 and 132 disposed on the third and fourth surfaces, wherein the external electrode includes conductive resin layers 131b and 132b including metal particles (sp, fp) and a resin (rs), the metal particles include spherical particles (sp) and plate-shaped particles (fp), a cross-section of the external electrodes 131 and 132 in first and second directions include a lower region LR disposed therebelow in the first direction and an upper region UR disposed thereabove in the first direction, and the conductive resin layer 131b and 132b may have a higher area ratio of spherical particles (sp) to the metal particles (sp, fp) in the upper region than in the lower region.

As a conductive resin layer is formed by applying a resin composition containing a conductive material, bending strength may be improved by absorbing external impacts, but there may be concern that equivalent series resistance (ESR) would increase.

Accordingly, there was an attempt to reduce ESR and secure bending strength by minimizing the conductive resin layer by making a thickness of the conductive resin layer in a lower region of the external electrode thicker than that in an upper region thereof, but there is a limitation that bending strength can only be secured by being mounted in a specific direction, and it may be difficult to sufficiently secure bending strength and moisture resistance reliability.

According to an embodiment of the present disclosure, by making an area ratio of spherical particles of the conductive resin layer different in upper and lower regions of the external electrodes 131 and 132, it is possible to reduce ESR and improve bending strength in both the upper and lower regions thereof, while preventing the size of the multilayer electronic component from increasing.

Hereinafter, each component included in the multilayer electronic component 100 according to an embodiment of the present disclosure will be described.

The body 110 may have a dielectric layer 111 and internal electrodes 121 and 122 alternately stacked.

Although the specific shape of the body 110 is not particularly limited, the body 110 may have a hexahedral shape or a shape similar to the hexahedral shape, as illustrated in the drawings. Due to shrinkage of ceramic powder particles included in the body 110 during a sintering process, the body 110 may not have a hexahedral shape having a perfectly straight line, but may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first and second surfaces 1 and 2, connected to the third and fourth surfaces 3 and 4, and opposing each other in a third direction.

As a margin region in which the internal electrodes 121 and 122 are not disposed overlaps the dielectric layer 111, a step portion may be formed by thicknesses of the internal electrodes 121 and 122, so that a corner connecting the first surface to the third to fifth surfaces and/or a corner connecting the second surface to the third to fifth surfaces may have a shape contracted to a center of the body 110 in the first direction when viewed with respect to the first surface or the second surface. Alternatively, by shrinkage behavior during the sintering process of the body 110, a corner connecting the first surface 1 to the third to sixth surfaces 3, 4, 5, and 6 and/or a corner connecting the second surface 2 to the third to sixth surfaces 3, 4, 5, and 6 may have a shape contracted to the center of the body 110 in the first direction when viewed with respect to the first surface or the second surface. Alternatively, as a corner connecting respective surfaces of the body 110 to each other is rounded by performing an additional process to prevent chipping defects, or the like, the corner connecting the first surface to the third to sixth surfaces and/or the corner connecting the second surface to the third to sixth surfaces may have a rounded shape.

Meanwhile, in order to suppress a step portion formed by the internal electrodes 121 and 122, after the internal electrodes are cut so as to be exposed to the fifth and sixth surfaces 5 and 6 of the body after lamination, when margin portions 114 and 115 are formed by stacking a single dielectric layer or two or more dielectric layers on both side surfaces of the capacitance formation portion (Ac) in a third direction (width direction), a portion connecting the first surface to the fifth and sixth surfaces and a portion connecting the second surface to the fifth and sixth surfaces may not have a contracted form.

A plurality of dielectric layers 111 forming the body 110 may be in a sintered state, and adjacent dielectric layers 111 may be integrated with each other, such that boundaries therebetween may not be readily apparent without use of a scanning electron microscope (SEM).

The dielectric layer 111 may be formed by preparing a ceramic slurry including a ceramic powder, an organic solvent and a binder, applying and drying the slurry on a carrier film to prepare a ceramic green sheet, and then sintering the ceramic green sheet. The ceramic powder is not particularly limited as long as sufficient capacitance may be obtained therewith, but, for example, barium titanate-based materials, lead composite perovskite-based materials, or strontium titanate-based materials may be used. For a more specific example, the ceramic powder may be barium titanate-based (BaTiO₃) powder, CaZrO₃-based paraelectric powder, or the like. For a more specific example, the barium titanate-based (BaTiO₃) powder may be at least one of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1), and the CaZrO₃-based paraelectric powder may be (Ca₁₋ₓSrₓ)(Zr_{1-y}Ti_{y})O₃ (0<x<1, 0<y<1).

Accordingly, the dielectric layer 111 may include at least one of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), and (Ca₁₋ₓSrₓ)(Zr_{1-y}Ti_{y})O₃ (0<x<1, 0<y<1). In an embodiment, the dielectric layer 111 may include (Ca₁₋ₓSrₓ)(Zr_{1-y}Ti_{y})O₃ (0<x<1, 0<y<1) as a main component.

Meanwhile, when a magnetic material is applied to the body 110 instead of a dielectric material, a composite electronic component may function as an inductor. The magnetic material may be, for example, ferrite and/or metal magnetic particles. When the composite electronic component functions as an inductor, the internal electrode may be a coil-type conductor.

In addition, when a piezoelectric material is applied to the body 110 instead of a dielectric material, the composite electronic component may function as a piezoelectric element. The piezoelectric material may be, for example, PZT (lead titanate zirconate).

In addition, when a ZnO-based or SiC-based material is applied to the body 110 instead of a dielectric material, the composite electronic component may function as a varistor, and when a spinel-based material is applied to the body 110 instead of a dielectric material, the composite electronic component may function as a thermistor.

That is, the composite electronic component 100 according to an embodiment of the present disclosure may function as an inductor, a piezoelectric element, a varistor, or a thermistor as well as a multilayer ceramic capacitor by appropriately changing a material or structure of the body 110.

A size of the body 110 is not particularly limited. For example, a length L of the body 110 in a second direction may be 3.1 to 3.3 mm, a thickness of the body 110 in a first direction may be 2.4 to 2.6 mm, and a width of the body 110 in a third direction may be 2.4 to 2.6 mm. However, an embodiment thereof is not limited thereto and may be appropriately modified depending on the usage environment and purpose thereof.

The body 110 may include a capacitance formation portion (Ac) disposed in the body 110, and including a first internal electrode 121 and a second internal electrode 122 disposed to oppose each other with the dielectric layer 111 interposed therebetween, and having capacitance formed therein, and cover portions 112 and 113 formed above and below the capacitance formation portion (Ac) in the first direction.

In addition, the capacitance formation portion (Ac) is a portion serving to contribute to capacitance formation of a capacitor, and may be formed by repeatedly stacking a plurality of first and second internal electrodes 121 and 122 with a dielectric layer 111 interposed therebetween.

The cover portions 112 and 113 may include an upper cover portion 112 disposed above the capacitance formation portion (Ac) in the first direction and a lower cover portion 113 disposed below the capacitance formation portion (Ac) in the first direction.

The upper cover portion 112 and the lower cover portion 113 may be formed by stacking a single dielectric layer or two or more dielectric layers 112-1, 112-2, 113-1, and 113-2 on the upper and lower surfaces of the capacitance formation portion (Ac) in a thickness direction, respectively, and the upper cover portion 112 and the lower cover portion 113 may serve to basically prevent damage to the internal electrodes due to physical or chemical stress.

The upper cover portion 112 and the lower cover portion 113 may not include internal electrodes, and may include the same material as that of the dielectric layer 111.

That is, the upper cover portion 112 and the lower cover portion 113 may include a ceramic material, for example, a barium titanate (BaTiO₃)-based ceramic material.

Meanwhile, a thickness of the cover portions 112 and 113 is not particularly limited. For example, the thickness “tc” of the cover portions 112 and 113 may be 100 μm or less, 30 μm or less, or 20 μm or less. Here, an average thickness of the cover portions 112 and 113 means an average thickness of each of the first cover portion 112 and the second cover portion 113.

The average thickness “tc” of the cover portions 112 and 113 may mean a size thereof in the first direction, and may be a value obtained by averaging sizes of the cover portions 112 and 113 in a first direction measured at 5 equally spaced points in a second direction in a cross-section of the body 110 in the first and second directions, cut at the center of the body 110 in a third direction.

In addition, margin portions 114 and 115 may be disposed on a side surface of the capacitance formation portion (Ac).

The margin portions 114 and 115 may include a first margin portion 114 disposed on the fifth surface 5 of the body 110 and a second margin portion 115 disposed on the sixth surface 6 of the body 110. That is, the margin portions 114 and 115 may be disposed on both end surfaces of the ceramic body 110 in a width direction.

The margin portions 114 and 115 may mean a region between both ends of the first and second internal electrodes 121 and 122 and a boundary surface of the body 110 in a cross-section of the body 110, cut in the width-thickness (W-T) direction, as illustrated in FIG. 3.

The margin portions 114 and 115 may basically serve to prevent damage to the internal electrodes due to physical or chemical stress.

The margin portions 114 and 115 may basically serve to prevent damage to the internal electrodes due to physical or chemical stress.

In addition, in order to suppress a step portion by the internal electrodes 121 and 122, after the internal electrodes are cut so as to be exposed to the fifth and sixth surfaces 5 and 6 of the body after lamination, the margin portions 114 and 115 may also be formed by stacking a single dielectric layer or two or more dielectric layers on both side surfaces of the capacitance formation portion (Ac) in the third direction (width direction).

Meanwhile, a width of the margin portions 114 and 115 is not particularly limited. For example, an average width of the margin portions 114 and 115 may be 100 μm or less, 20 μm or less, or 15 μm or less. Here, the average width of the margin portions 114 and 115 means an average thickness of each of the first margin portion 114 and the second margin portion 115.

The average width of the margin portions 114 and 115 may mean an average size MW1 of a region in which the internal electrode is spaced apart from the fifth surface in the third direction and an average size MW2 of a region in which the internal electrode is spaced apart from the sixth surface in the third direction, and may be a value obtained by averaging sizes of the margin portions 114 and 115 in the third direction, measured at 5 equally spaced points on a side surface of the capacitance formation portion (Ac).

The internal electrodes 121 and 122 may include first and second internal electrodes 121 and 122. The first and second internal electrodes 121 and 122 may be alternately disposed to face each other with the dielectric layer 111 forming the body 110 interposed therebetween, and may be exposed to the third and fourth surfaces 3 and 4 of the body 110, respectively.

The first internal electrode 121 may be spaced apart from the fourth surface 4 and be exposed through the third surface 3, and the second internal electrode 122 may be spaced apart from the third surface 3 and be exposed through the fourth surface 4. A first external electrode 131 may be disposed on the third surface 3 of the body and be connected to the first internal electrode 121, and a second external electrode 132 may be disposed on the fourth surface 4 of the body and be connected to the second internal electrode 122.

That is, the first internal electrode 121 is not connected to the second external electrode 132 and is connected to the first external electrode 131, and the second internal electrode 122 is not connected to the first external electrode 131 and is connected to the second external electrode 132. Accordingly, the first internal electrode 121 may be formed to be spaced apart from the fourth surface 4 by a predetermined distance, and the second internal electrode 122 may be formed to be spaced apart from the third surface 3 by a predetermined distance. In addition, the first and second internal electrodes 121 and 122 may be disposed to be spaced apart from the fifth and sixth surfaces of the body 110.

However, it is not limited to this form, and the first internal electrode and the second internal electrode are alternately disposed with a dielectric layer therebetween, and the first internal electrode may include a 1 -1 internal electrode connected to a first external electrode and a 1-2 internal electrode connected to a second external electrode, and the second internal electrode may have a floating electrode form disposed to be spaced apart from the first and second external electrodes.

In addition, although it is illustrated that the first internal electrode 121 and the second internal electrode 122 are disposed alternately in the first direction with the dielectric layer 111 interposed therebetween, it is not limited thereto, and in an embodiment, the first internal electrode and the second internal electrode may be disposed alternately in the third direction with the dielectric layer interposed therebetween.

The conductive metal included in the internal electrodes 121 and 122 may be at least one of Ni, Cu, Pd, Ag, Au, Pt, In, Sn, Al, Ti, and alloys thereof, but the present disclosure is not limited thereto.

An average thickness “td” of the dielectric layer 111 is not particularly limited, but may be, for example, 0.1 μm to 10 μm. An average thickness “te” of the internal electrodes 121 and 122 is not particularly limited, but may be, for example, 0.05 μm to 3.0 μm.In addition, the average thickness “td” of the dielectric layer 111 and the average thickness “te” of the internal electrodes 121 and 122 may be arbitrarily set according to the desired characteristics or purpose thereof.

The average thickness “td” of the dielectric layer 111 and the average thickness “te” of the internal electrodes 121 and 122 refer to sizes of the dielectric layer 111 and the internal electrodes 121 and 122 in the first direction, respectively. The average thickness “td” of the dielectric layer 111 and the average thickness “te” of the internal electrodes 121 and 122 may be measured by scanning the cross-section of the body 110 in the first and second directions using a scanning electron microscope (SEM) at a magnification of 10,000. More specifically, an average value may be measured by measuring a thickness of one dielectric layer 111 at a plurality of points of one dielectric layer 111, for example, at 30 equally spaced points in the second direction. In addition, an average value may be measured by measuring a thickness of one internal electrode (121, 122) at a plurality of points of one internal electrode (121, 122), for example, at 30 equally spaced points in the second direction. The 30 equally spaced points may be designated in a capacitance formation portion (Ac). Meanwhile, when the measurement of an average value is performed for each of 10 dielectric layers 111 and 10 internal electrodes 121 and 122, and then an average value thereof is measured, the average thickness “td” of the dielectric layer 111 and the average thickness “te” of the internal electrodes 121 and 122 may be further generalized.

External electrodes 131 and 132 may be disposed on the third and fourth surfaces of the body 110.

The external electrodes 131 and 132 may be respectively disposed on the third and fourth surfaces 3 and 4 of the body 110, as shown in FIG. 2, and may include first and second external electrodes 131 and 132 respectively connected to the first and second internal electrodes 121 and 122.

In the present embodiment, a structure in which the multilayer electronic component 1000 has two external electrodes 131 and 132 is described, but the number and shape of the external electrodes 131 and 132 may be changed depending on the shape of the internal electrodes 121 and 122 or other purposes thereof.

The external electrodes 131 and 132 may include conductive resin layers 131b and 132b including metal particles (sp, fp) and a resin (rs). In addition, the metal particles (sp, fp) may include spherical particles (sp) and plate-shaped particles (fp).

A cross-section of the external electrodes in first and second direction may include a lower region LR disposed therebelow in the first direction and an upper region UR disposed thereabove in the first direction, and the conductive resin layer may have a higher area ratio of an area of spherical particles (sp) to an area of the metal particles (sp, fp) in the upper region UR than in the lower region LR. Since the conductive resin layers 131b and 132b have a higher area ratio of spherical particles (sp) in the upper region (UR) than in the lower region LR, it is possible to reduce ESR and sufficiently secure bending strength, while minimizing a volume of the external electrodes 131 and 132.

The resin (rs) included in the conductive resin layers 131b and 132b may play a role in securing bonding properties and absorbing impacts, and the metal particles (sp, fp) may play a role in electrically connecting the internal electrodes 121 and 122 and the external electrodes 131 and 132.

The resin (rs) included in the conductive resin layers 131b and 132b is not particularly limited as long as it has bonding properties and impact absorption properties, and can be mixed with a conductive metal powder to make a paste, and may include, for example, an epoxy resin. A ratio of spherical particles (sp) among metal particles (sp, fp) is an important factor in determining static viscosity of a paste for forming the conductive resin layers 131b and 132b. Here, the static viscosity may mean viscosity in a situation in which, when a body is dipped into the paste and then is lifted, the paste is elongated by an external force and then breaks, and immediately after the paste breaks, the paste slowly flows and an applied shape thereof is determined. When the ratio of spherical particles (sp) among metal particles (sp, fp) is high, static viscosity is high, so it is easy to maintain the shape even in the paste state. On the other hand, when the ratio of spherical particles (sp) among metal particles (sp, fp) is low, static viscosity is low, so the fluidity is high after paste application, and it is easy to flow down by gravity. In other words, the ratio of plate-shaped particles (fp) and spherical particles (sp) is an important factor in determining static viscosity.

According to an embodiment of the present disclosure, since the conductive resin layers 131b and 132b have a higher area ratio of spherical particles (sp) in the upper region UR than in the lower region LR, the upper region UR is easy to maintain the shape even in a paste state, so that conductive resin layers 131b and 132b may be sufficiently formed at a corner connecting the third surface and the second surface and a corner connecting the fourth surface and the second surface.

In an embodiment, the upper region UR and the lower region LR may include a convex shape in the second direction, respectively. Since the upper region UR and the lower region LR may be vulnerable to externally transmitted stress, the upper region UR and the lower region LR may have a convex shape to increase resistance to external stress, thereby improving the bending strength. In general, the lower region LR is more affected by stress due to substrate bending, or the like, than the upper region UR, but when only the lower region LR is thickened, the lower region LR should be mounted close to a mounting surface to improve the bending strength.

In addition, conventionally, a method of forming external electrodes by dipping a body in a paste for external electrodes was mainly used. When forming external electrodes by the dipping method, in order to form the external electrodes to be sufficiently thick at a corner connecting the third surface to the first, second, fifth, and sixth surfaces and a corner connecting the fourth surface to the first, second, fifth, and sixth surfaces, the thickness of the external electrodes may become very thick in the central portion of the third and fourth surfaces, and thus the capacitance per unit volume of the multilayer electronic component may decrease. In addition, when only the lower region LR is thickened, the external electrode may be formed sufficiently thick at a corner connecting the third surface and the first surface and a corner connecting the fourth surface and the first surface, but it is difficult to form the external electrode sufficiently thick at a corner connecting the third surface and the second surface and a corner connecting the fourth surface and the second surface, so there is a concern that the plating layer may be broken or moisture and/or plating solution may penetrate, resulting in a decrease in moisture resistance reliability.

On the other hand, according to an embodiment of the present disclosure, external electrodes 131 and 132 may also be sufficiently formed at the corner connecting the second surface and the third surface and at the corner connecting the second surface and the fourth surface, thereby preventing breakage of the plating layers 131c and 132c and blocking a penetration path of moisture and/or plating solution, thereby improving moisture resistance reliability.

In an embodiment, the external electrodes 131 and 132 may include a concave shape in the second direction between a convex shape in the upper region UR and a convex shape in the lower region LR.

In addition, as shown in FIG. 1, the convex shape of the external electrodes 131 and 132 in the upper region UR may be disposed continuously in the third direction, and the convex shape of the external electrodes 131 and 132 in the lower region LR may also be disposed continuously in the third direction. Accordingly, the external electrodes 131 and 132 may have a form in which the concave shape in the central portion in the first direction is formed continuously in the third direction.

In an embodiment, when a maximum thickness of the external electrode in the second direction in the lower region LR is tm1, a maximum thickness of the external electrode in the second direction in the upper region UR is tm2, and a minimum thickness of the external electrode in the second direction in the central portion in the first direction is tmin, tmin<tm1 and tmin<tm2 may be satisfied. Accordingly, it is possible to reduce ESR and sufficiently secure bending strength, while minimizing the volume of the external electrodes 131 and 132. For a specific example, tmin/tm1 may be 0.1 or more and 0.9 or less, and tmin/tm2 may be 0.1 or more and 0.9 or less.

Referring to FIG. 5, the upper region UR may be a region disposed from the center of the body 110 in the first direction among the external electrodes to an extension line E2 of the second surface, and the lower region LR may be a region disposed from the center of the body 110 in the first direction among the external electrodes to an extension line E1 of the first surface. Meanwhile, the central portion of the external electrode in the first direction may be a region located in the middle, when a region from the extension line E1 of the first surface to the extension line E2 of the second surface is divided into three equal parts.

In addition, the tm1, tm2 and tmin may be measured from the cross-section of the body in the first and second directions cut at the center of the body in the third direction.

The external electrodes 131 and 132 may include band portions extending to portions of the first and second surfaces. In addition, the external electrodes 131 and 132 may include side band portions 131sb and 132sb extending to portions of the fifth and sixth surfaces.

Referring to FIG. 5, the side band portions 131sb and 132sb may have a length which deceases in the second direction from an uppermost end of the body in the first direction toward the central portion of the body in the first direction, and may have a length which deceases in the second direction from a lowermost end of the body in the first direction toward the central portion of the body in the first direction. Accordingly, the volume of the external electrode may be minimized while improving the bending strength on the upper and lower surfaces where external stress is concentrated.

In an embodiment, the external electrodes 131b and 132b may include side band portions 131sb and 132sb extending to portions of the fifth and sixth surfaces 5 and 6, the external electrodes 131 and 132 may include a first external electrode 131 disposed on the third surface and a second external electrode 132 disposed on the fourth surface 4, and when a minimum length in the second direction from an extension line E3 of the third surface to the end of the side band portion 131sb of the first external electrode in the central portion in the first direction is Lbc, a length in the second direction from the extension line E3 of the third surface to the end of the side band portion 131sb of the first external electrode at the lowermost end of the body in the first direction is Lb1, and a length in the second direction from the extension line E3 of the third surface to the end of the side band portion 131sb of the first external electrode at the uppermost end of the body in the first direction is Lb2, Lbc<Lb1 and Lbc<Lb2 can be satisfied. Accordingly, the volume of the external electrode may be minimized while improving the bending strength on the upper and lower surfaces where external stress is concentrated.

For example, Lbc/Lb1 may be 0.1 or more and 0.9 or less, and Lbc/Lb2 may be 0.1 or more and 0.9 or less.

In an embodiment, the external electrodes 131 and 132 may further include electrode layers 131a and 132a disposed on the body and connected to the internal electrode, and the conductive resin layers 131b and 132b may be disposed on the electrode layers 131a and 132a.

The electrode layers 131a and 132a may include metal and may be in direct contact with the internal electrodes 121 and 122 to serve to electrically connect the external electrodes 131 and 132 and the internal electrodes 121 and 122.

In an embodiment, the electrode layers 131a and 132a may further include glass. As the electrode layers 131a and 132a further include glass, the bonding strength with the body may be improved, thereby improving the coupling strength between the external electrodes 131 and 132 and the body 110. The electrode layers 131a and 132a may be sintered electrodes formed by applying and sintering a paste containing glass and metal to the body.

A material having excellent electrical conductivity may be used as the metal included in the electrode layers 131a and 132a, and is not particularly limited. For example, the metal included in the electrode layers 131a and 132a may be at least one of nickel (Ni), copper (Cu), and alloys thereof, and more preferably, may be Cu.

In an embodiment, the electrode layers 131a and 132a may include a convex shape in the second direction in the central portion in the first direction.

In an embodiment, when a thickness of the electrode layers 131a and 132a in the second direction in the central portion in the first direction is ta1, when a thickness of the electrode layers in the second direction in an internal electrode disposed at an uppermost end of internal electrodes in the first direction connected to the electrode layers is ta2, and a thickness of the electrode layer in an internal electrode disposed at a lowermost end of internal electrodes in the first direction connected to the electrode layers is ta3, ta1>ta2 and ta1>ta3 may be satisfied.

For a specific example, ta1/ta2 may be greater than 1 and 20 or less, and ta1/ta3 may be greater than 1 and 20or less. In addition, ta1/ta2 may be 1.2 or more and 10 or less, and ta1/ta3 may 1.2 or more and 10 or less.

Meanwhile, the central portion in the first direction may be a region located in the middle, when a region from the extension line E1 of the first surface to the extension line E2 of the second surface is divided into three equal parts, and ta1 may mean a maximum thickness of the electrode layer in the second direction in the central portion in the first direction.

In addition, the ta1, ta2 and ta3 may be measured in the cross-section of the body in the first and second direction, cut at the center of the body in the third direction.

In an embodiment, the body 110 may include margin portions 114 and 115, which is a region in which the internal electrode is spaced apart from the fifth and sixth surfaces, and the upper region UR and the lower region LR may include a convex shape in the second direction, respectively, in the cross-section of the external electrodes 131 and 132 in the first and second directions, cut at the margin portions 114 and 115.

In this case, the external electrodes 131 and 132 may include a concave shape in the second direction between the convex shape in the upper region UR and the convex shape in the lower region LR.

Metal particles (sp, fp) included in the conductive resin layers 131b and 132b may exist in a randomly dispersed form. The metal particles (sp, fp) included in the conductive resin layers 131b and 132b may have a form in which spherical particles (sp) and plate-shaped particles (fp) are mixed. However, an embodiment thereof is not limited thereto, and the metal particles in some regions of the conductive resin layers 131b and 132b may be formed only of spherical particles (sp), or some regions of the conductive resin layers 131b and 132b may be formed by applying a paste including metal particles and a resin comprised only of spherical particles. In addition, the metal particles (sp, fp) do not have to be comprised only of spherical particles (sp) and plate-shaped particles (fp), and may include particles of other shapes.

The metal particles (sp, fp) may include at least one of Ag, Cu, and Sn. In addition, the metal particles (sp, fp) may further include Bi, Pb, etc.

In an embodiment, the conductive resin layers 131b and 132b may include first layers 131b-1 and 132b-1 disposed in the lower region LR and second layers 131b-2 and 131b-2 disposed in the upper region UR, and the second layers 131b-2 and 131b-2 may have a higher area ratio of spherical particles (sp) to metal particles (sp, fp) than the first layers 131b-1 and 132b-1.

Meanwhile, the resin (rs) included in the conductive resin layers 131b and 132b may be, for example, an epoxy resin, and the present disclosure is not limited thereto, and may be, for example, a bisphenol A resin, a glycol epoxy resin, a novolak epoxy resin, or a derivative thereof, which has a low molecular weight and is liquid at room temperature.

In addition, the resin included in the first layers 131b-1 and 132b-1 may be the same type of resin as the resin included in the second layers 131b-2 and 132b-2.

However, an embodiment thereof is not limited thereto, and the resin included in the first layers 131b-1 and 132b-1 may be of a different type from the resin included in the second layers 131b-2 and 132b-2. For a specific example, since the molecular weight of the resin may affect static viscosity, the molecular weight of the resin included in the first layers 131b-1 and 132b-1 may be controlled to be smaller than the molecular weight of the resin included in the second layers 131b-2 and 132b-2.

In an embodiment, the first layers 131b-1 and 132b-1 may have an area ratio of spherical particles to metal particles of 50% or more and 70% or less, and the second layers 131b-2 and 132b-2 may have an area ratio of spherical particles to metal particles of 97.5% or more. Accordingly, it is possible to reduce ESR and improve bending strength in both the upper and lower regions, while preventing the size of the multilayer electronic component from increasing. In general, as a ratio of the plate-shaped particles in a paste increases, fluidity of the paste increases and static viscosity decreases. Therefore, the first layers 131b-1 and 132b-1 may be configured to reduce static viscosity and induce a flowing shape during a drying process immediately after application, while the second layers 131b-2 and 132b-2 may be configured to be comprised mainly of spherical particles to increase static viscosity.

When the area ratio of spherical particles to metal particles in the first layers 131b-1 and 132b-1 is less than 50%, there is a concern that static viscosity of the paste may become too low, and when the area ratio thereof exceeds 70%, as the static viscosity increases, the thickness of the central portion of the external electrode in the first direction may increase, so that there is a concern in that the size of the multilayer electronic component may be increased.

When an area ratio of spherical particles to metal particles in the second layers 131b-2 and 132b-2 is less than 97.5%, the static viscosity may decrease, which may make it difficult to form a convex shape thereof in the upper region UP.

In an embodiment, an area ratio of the metal particles (sp, fp) in the first layers 131b-1 and 132b-1 may be 60% or more and 70% or less, and the area ratio of the metal particles (sp, fp) in the second layers 131b-2, and 132b-2 may be 70% or more and 90% or less.

When the area ratio of the metal particles (sp, fp) in the first layers 131b-1 and 132b-1 is less than 60%, there is a concern that ESR may increase, and when the area ratio exceeds 70%, there is a concern that the bending strength may decrease.

When the area ratio of the metal particles (sp, fp) in the second layers 131b-2 and 132b-2 is less than 70%, there is a concern that ESR may increase, and when the area ratio exceeds 90%, there is a concern that the bending strength may decrease.

An average size of the metal particles (sp, fp) does not need to be particularly limited. For example, the average size of the metal particles (sp, fp) may be 0.2 to 20 μm. Meanwhile, the average thickness of the metal particles (sp, fp) may be measured from an image obtained by scanning a cross-section of the body 110 in the first and second directions (L-T cross-section), taken at the central portion of the body 110 in the third direction, with a SEM. In the image, the average size may be the sizes of 10 or more metal particles (sp, fp), and meanwhile, when assuming a circle having the same area as the area of the metal particles (sp, fp), for the size of one metal particles (sp, fp), a diameter of the virtual circle may be the size of the metal particles (sp, fp).

In general, spherical particles (sp) and plate-shaped particles (fp) have a large difference in a length ratio of a minor axis to a major axis, sufficiently to be distinguished from each other with the naked eye. Therefore, the length ratio of the minor axis to the major axis of the spherical particles (sp) and the plate-shaped particles (fp) is not particularly limited, but, for example, the length ratio of the minor axis to the major axis of the spherical particles (sp) may be 1.45 or less, and the length ratio of the minor axis to the major axis of the plate-shaped particles (fp) may be 1.95 or more.

An area ratio of spherical particles (sp) to metal particles (sp, fp), an area ratio of metal particles (sp, fp) in the first layers 131b-1 and 132b-1, an area ratio of metal particles (sp, fp) in the second layers 131b-2 and 132b-2, the length ratio of the minor axis to the major axis of the metal particles (sp, fp), and the like, may be measured in the cross-section of the body in the first and second directions (L-T cross-section) polished to ½ point of the body in the third direction.

Specifically, after obtaining an image of the L-T cross-section using a scanning electron microscope (SEM) at a magnification of 3000 times or more, the metal particles and the resin in the conductive resin layers 131b and 132b may have different colors or shades, and thereby, an area ratio of the metal particles (sp, fp) in the conductive resin layers 131b and 132b may be obtained. In addition, by analyzing the image using energy dispersive spectroscopy (EDS), the metal particles (sp, fp) and the resin may be distinguished more clearly.

In addition, spherical particles (sp) and plate-shaped particles (fp) may be distinguished with the naked eyes in the image above, or particles having a length ratio of the major axis to the minor axis of 1.45 or less may be selected as spherical particles, and an area ratio of the spherical particles (sp) to the metal particles (sp, fp) may be measured.

The area ratio of spherical particles (sp) to metal particles (sp, fp) in the upper region UR may be an average value of values measured in three regions equally spaced in the first direction in the upper region UR of the L-T cross-section. The area ratio of spherical particles (sp) to metal particles (sp, fp) in the lower region UR may be an average value obtained by measuring values in three regions equally spaced in the first direction in the lower region UR of the L-T cross-section.

Plating layers 131c and 132c plays a role in improving the mounting characteristics. The type of the plating layers 131c and 132c is not particularly limited, and may be a plating layer including at least one of Ni, Sn, Pd, and alloys thereof, and may be formed of a plurality of layers.

For a more specific example of the plating layers 131c and 132c, the plating layers 131c and 132c may be a Ni plating layer or a Sn plating layer, and may be in a form in which a Ni plating layer and a Sn plating layer are formed sequentially, or may be in a form in which a Sn plating layer, a Ni plating layer, and a Sn plating layer are formed sequentially. In addition, the plating layers 131c and 132c may include a plurality of Ni plating layers and/or a plurality of Sn plating layers.

In an embodiment, first layers 131b-1 and 132b-1 may also be disposed in the upper region UL, and the second layers 131b-2 and 132b-2 may be disposed in the first layers 131b-1 and 132b-1 in the upper region UL.

By first applying a paste having low static viscosity to the third and fourth surfaces of the body, and then applying a paste having high static viscosity to the upper region UR and performing a curing heat treatment to form a conductive resin layer, the first layers 131b-1 and 132b-1 may also be disposed in the upper region UR.

In addition, the first layers 131b-1 and 132b-1 may have an average thickness in the second direction in the upper region UR, which is thinner than an average thickness in the second direction in the lower region LR. Meanwhile, the average thickness in the second direction may be an average value of thickness values measured at 5 points equally spaced in the first direction.

Meanwhile, the first layer 131b-1 and 132b-1 may not necessarily have to be further disposed in the upper region UR, and the first layer 131b-1 and 132b-1 may not be disposed in the upper region UR.

Furthermore, referring to FIG. 7, which is a drawing corresponding to FIG. 2 of a multilayer electronic component 100′ according to another embodiment of the present disclosure, first layers 131b-1′ and 132b-1′ and second layers 132b-1′ and 132b-2′ may be disposed to be spaced apart from each other. External electrodes 131′ and 132′ may include electrode layers 131a′ and 132a′ and conductive resin layers 131b′ and 132b′. The electrode layers 131a′ and 132a′ may include a region not covered by the conductive resin layers 131b′ and 132b′, and plating layers 131c′ and 132c′ may be disposed in the uncovered region.

Hereinafter, a method for manufacturing the multilayer electronic component according to an embodiment of the present disclosure described above will be exemplarily described. However, the method for manufacturing a multilayer electronic component 100 is not limited thereto.

First, a ceramic powder for forming a dielectric layer (111) is prepared. The ceramic powder may include, for example, at least one of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ)(Zr_{1-y}Ti_{y})O₃ (0<x≤0.5, 0<y≤0.5). BaTiO₃ powder may be synthesized, for example, by reacting a titanium raw material such as titanium dioxide with a barium raw material such as barium carbonate. Methods for synthesizing the above ceramic powder include, for example, a solid-state method, a sol-gel method, a hydrothermal synthesis method, etc., but the present disclosure is not limited thereto. Next, the prepared ceramic powder is dried and ground, and then an organic solvent such as ethanol and a binder such as polyvinyl butyral are mixed to prepare a ceramic slurry, and the ceramic slurry is applied and dried on a carrier film to prepare a ceramic green sheet.

Next, an internal electrode pattern is formed by printing a paste for internal electrodes including metal powder, a binder, an organic solvent, and the like, by a predetermined thickness on a ceramic green sheet using a screen printing method, a gravure printing method, or the like.

Thereafter, the ceramic green sheet on which an internal electrode pattern is printed is peeled off from a carrier film, and then a ceramic green sheet is stacked and pressed in a predetermined number of layers thereof, to form a ceramic laminate. A ceramic green sheet on which an internal electrode pattern is not formed may be stacked in a predetermined number of layers thereof, in order to form cover portions 112 and 113 after sintering in upper and lower portions of the ceramic laminate. Thereafter, the ceramic laminate may be cut to have a predetermined chip size, and the cut chip may be sintered at a temperature of 1000° C. or higher and 1400° C. or lower to form a body 110.

Meanwhile, margin portions 114 and 115 may be formed by applying and sintering a conductive paste for internal electrodes except for a region in which a margin portion is to be formed on the ceramic green sheet. Alternatively, in order to suppress a step portion formed by the internal electrodes 121 and 122, the ceramic laminate may be cut so that an internal electrode pattern is exposed to both surfaces of the cut chip in the third direction, and then a sheet for forming a margin portion may be attached on both surfaces of the cut chip in the third direction and then sintered to form margin portions 114 and 115.

Next, external electrodes 131 and 132 are formed. For example, electrode layers 131a and 132a may be formed by dipping the body 110 into a conductive paste for external electrodes including metal powder, glass frit, a binder, and an organic solvent, and then sintering the conductive paste for the external electrodes at a temperature within a range of 500 to 900° C. to form a sintered electrode layer.

Thereafter, conductive resin layers 131b and 132b may be formed by using a paste for a first layer including a conductive resin composition including metal particles, a resin, a binder, and an organic solvent, and a paste for a second layer having a higher ratio of spherical particles than that of the paste for the first layer.

First, after the paste for the first layer is applied to the electrode layer and tilted so that the paste flows down toward a lower region thereof and the external electrode in the lower region becomes thicker, the paste for the second layer having high static viscosity is applied to an upper region thereof and a corner of the second surface, and may be subjected to curing heat treatment to form conductive resin layers 131b and 132b.

Thereafter, electrolytic plating and/or electroless plating may be additionally performed to form plating layers 131c and 132c.

According to above-described embodiments, as one of the various effects of the present disclosure, by making an area ratio of spherical particles of a conductive resin layer in an upper region and a lower region different, it is possible to reduce ESR and improve bending strength in both the upper and lower regions, while preventing the size of the multilayer electronic components from increasing.

As one of the various effects of the present disclosure, it is possible to prevent an external electrode at a corner portion from being formed thinly, thereby suppressing plating breakage defects and improving moisture resistance reliability.

However, various advantages and effects of the present disclosure are not limited to the above-described contents, and can be more easily understood in a process of explaining specific embodiments of the present disclosure.

Although the embodiments of the present disclosure have been described in detail above, the present disclosure is not limited by the above-described embodiments and the attached drawings, but is intended to be limited by the appended claims. Accordingly, various forms of substitution, modification, and change may be made by those skilled in the art within the scope that does not depart from the technical idea of the present disclosure described in the claims, and this will also fall within the scope of the present disclosure.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it can be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

While example embodiments have been illustrated and described above, it will be apparent to those skilled in the art that modifications and variations could be made without departing from the scope of the present disclosure as defined by the appended claims.

What is claimed is:

1. A multilayer electronic component, comprising:
a body including a dielectric layer and an internal electrode, the body including a first surface and a second surface opposing each other in a first direction, a third surface and a fourth surface connected to the first surface and the second surface and opposing each other in a second direction, and a fifth surface and a sixth surface connected to the first surface, the second surface, the third surface, and the fourth surface and opposing each other in a third direction; and
an external electrode disposed on the third surface and the fourth surface,
wherein the external electrode includes a conductive resin layer including metal particles and a resin, and the metal particles include spherical particles and plate-shaped particles,
wherein a cross-section of the external electrode in the first direction and the second direction includes a lower region disposed below in the first direction and an upper region disposed above in the first direction, and
wherein the conductive resin layer has a higher area ratio of spherical particles to the metal particles in the upper region than in the lower region.

2. The multilayer electronic component of claim 1, wherein each of the upper region and the lower region of the cross-section of the external electrode includes a convex shape in the second direction.

3. The multilayer electronic component of claim 2, wherein the external electrode includes a concave shape in the second direction between the convex shape in the upper region and the convex shape in the lower region.

4. The multilayer electronic component of claim 1, wherein:
a maximum thickness of the external electrode in the second direction in the lower region is tm1,
a maximum thickness of the external electrode in the second direction in the upper region is tm2,
a minimum thickness of the external electrode in the second direction in a central portion thereof in the first direction is tmin, and
tmin<tm1 and tmin<tm2 are satisfied.

5. The multilayer electronic component of claim 1, wherein the external electrode comprises a side band portion extending to a portion of each of the fifth surface and the sixth surface, and
wherein a first length of the side band portion in the second direction decreases from an uppermost end of the body in the first direction to a central portion of the body in the first direction, and a second length of the side band portion in the second direction decreases from a lowermost end of the body in the first direction to the central portion of the body in the first direction.

6. The multilayer electronic component of claim 1, wherein:
the external electrode comprises a side band portion extending to a portion of each of the fifth surface and the sixth surface,
the external electrode includes a first external electrode disposed on the third surface and a second external electrode disposed on the fourth surface,
a minimum length in the second direction from an extension line of the third surface to an end of the side band portion of the first external electrode in a central portion in the first direction is Lbc,
a length in the second direction from the extension line of the third surface to the end of the side band portion of the first external electrode at a lowermost end of the body in the first direction is Lb1,
a length in the second direction from the extension line of the third surface to the end of the side band portion of the first external electrode at an uppermost end of the body in the first direction is Lb2, and
Lbc<Lb2 and Lbc<Lb1 are satisfied.

7. The multilayer electronic component of claim 1, wherein:
the external electrode further includes an electrode layer disposed on the body and connected to the internal electrode, and
the conductive resin layer is disposed on the electrode layer.

8. The multilayer electronic component of claim 7, wherein the electrode layer includes a convex shape in the second direction in the central portion in the first direction.

9. The multilayer electronic component of claim 7, wherein:
a first thickness of the electrode layer in the second direction in the central portion in the first direction is ta1,
a second thickness of the electrode layer in the second direction in the internal electrode disposed at an uppermost end of internal electrodes in the first direction, connected to the electrode layer is ta2,
a third thickness of the electrode layer in the second direction in an internal electrode disposed at a lowermost end of internal electrodes in the first direction, connected to the electrode layer is ta3, and
ta1>ta2 and ta1>ta3 are satisfied.

10. The multilayer electronic component of claim 1, wherein:
the body includes a margin portion disposed between the internal electrode and the fifth surface and the sixth surface, and
each of the upper region and the lower region of cross-section of the external electrode has a convex shape in the second direction.

11. The multilayer electronic component of claim 10, wherein the external electrode includes a concave shape in the second direction between a convex shape of the external electrode disposed in the upper region and a convex shape of the external electrode disposed in the lower region.

12. The multilayer electronic component of claim 1, wherein:
the conductive resin layer includes a first layer disposed in the lower region and a second layer disposed in the upper region, and
the second layer has a higher area ratio of spherical particles to metal particles than the first layer.

13. The multilayer electronic component of claim 12, wherein:
the first layer has an area ratio of spherical particles to metal particles of 50% or more and 70% or less, and
the second layer has an area ratio of spherical particles to metal particles of 97.5% or more.

14. The multilayer electronic component of claim 12, wherein an area ratio of the metal particles to total particles in the first layer is 60% or more and 70% or less, and
an area ratio of the metal particles to total particles in the second layer is 70% or more and 90% or less.

15. The multilayer electronic component of claim 12, wherein:
the spherical particles have a first length ratio of a minor axis to a major axis of 1.45 or less, and
plate-shaped particles have a second length ratio of the minor axis to the major axis of 1.95 or more.

16. The multilayer electronic component of claim 12, wherein the first layer is disposed in the upper region, and
the second layer is disposed on the first layer in the upper region.

17. The multilayer electronic component of claim 16, wherein the first layer has an average thickness in the second direction in the upper region thinner than an average thickness in the second direction in the lower region.

18. The multilayer electronic component of claim 12, wherein the first layer and the second layer are spaced apart from each other.
